(19) United States
(12) Patent Application Publication
(10) Pub. No.: US 2013/0017447 A1
(43) Pub. Date: Jan. 17, 2013

(54) Positive Electrode Material

(71) Applicants: Cécile Tessier, Bruges (FR); Stephane Levasseur, Brussels (BE); Philippe Biensan, Carignan de Bordeaux (FR); Julien Breger, Bordeaux (FR)

(72) Inventors: Cécile Tessier, Bruges (FR); Stephane Levasseur, Brussels (BE); Philippe Biensan, Carignan de Bordeaux (FR); Julien Breger, Bordeaux (FR)

(21) Appl. No.: 13/497,104

(22) PCT Filed: Sep. 24, 2010
(86) PCT No.: PCT/EP10/05845

§ 371 Date: Oct. 1, 2012

Related U.S. Application Data
(60) Provisional application No. 61/277,417, filed on Sep. 24, 2009.

(51) Int. Cl. H01B 1/06; H01M 4/133; H01M 4/131; B82Y 30/00

(52) U.S. Cl. 429/221; 252/519.14; 252/519.12; 429/231.8; 429/231.95; 429/224; 977/773

(57) ABSTRACT

An electrode material comprising a LiₓFe_{y}M_{z}P_{w}04 compound for an electrode for a Li rechargeable battery, wherein 0.90<=x<=1.03, 0.85<=y<=1.0, 0.01<=z<=0.15, 0.90<=w<=1.0, 1.9<=x+y+z<=2.1; wherein M comprises at least one element selected from the group consisting of Mn, Co, Mg, Cr, Zn, Al, Ti, Zr, Nb, Na, and Ni; and wherein the compound comprises a charge transfer resistance increase of less than 20% between room temperature and 0° C.

### FIELD OF THE INVENTION

The present invention relates generally to the field of electrode materials. More specifically, embodiments of the present invention relate to modification of rechargeable battery electrode materials.

### BACKGROUND

Since the original work of Padhi et al. (JES, 144 (1997), 1188), phospho-olivines LiMPO₄ (with M=Fe, Ni, Co, Mn, . . . ) have been potential candidates for cathode materials in Li batteries. Among all of the isostructural compositions, LiFePO₄ is the most investigated and its commercialization has been realized due to its high performances with respect to its reversible capacity, rate properties and cycle life (International Publication Number WO2004/001881 A2).

However, phospho-olivines materials suffer from poor electronic and ionic conductivity (Delacourt et al., JES, 152 (2005) A913). Therefore, a need for optimising the microstructure of these compounds exists.

Processing applications such as carbon coating ensured that Li⁺ ions may be extracted out of LiFePO₄ leading to room-temperature capacities of ˜160 mAh/g, i.e. close to theoretical capacity of 170 mAh/g (WO2004/001881).

Additionally, one of the main concerns regarding the use of these LiMPO₄ compounds in real systems, particularly in demanding applications such as electric cars, is the significant loss of power performances of these LiMPO₄ compounds when working at low temperature (at or below 0° C.).

To this end, a process is described yielding metal phosphate powders offering essential improvements over the materials cited above.

### BRIEF SUMMARY

The embodiments of the invention include an electrode material with the formula LiₓMPO₄, wherein M comprises at least one metal, wherein 0≦x≦1, and wherein the LiₓMPO₄ comprises a temperature independent charge transfer resistance.

Other embodiments describe a positive electrode material with the formula LiₓM_{1-y}M_{y}PO₄ with a carbon coating, wherein the LiₓM_{1-y}M_{y}PO4 material contains about less than 3% carbon and wherein M_{1-y} comprises Fe and M_{y} comprises Mn. Further, 0≦x≦1 and 0≦y≦1 and the LiₓMPO₄ comprises an R_{CT} constant of less than about 60 Ohm at about 0 C. The charge transfer resistance is independent of temperature.

### BRIEF DESCRIPTION OF THE SEVERAL VIEWS OF THE DRAWINGS

FIG. 1: Impedance spectroscopy plot ImZ=f (ReZ) of material according to the embodiments of the invention and state of the art material at 50% DOD, RT and 0° C.

FIG. 2: Cyclic voltammetry measurement I=f(E) of the state of the art material (counter example) at RT and 0° C.

### DETAILED DESCRIPTION OF THE EMBODIMENTS OF THE INVENTION

The embodiments cover a LiₓMPO₄ material with temperature independent R_{CT} values. According to some embodiments, the R_{CT} values are lower than 100 Ohm when measured at 0° C. by cyclic voltammetry. In other embodiments, the R_{CT} values are lower than 60 Ohm at 0° C. when measured by cyclic voltammetry.

For battery applications, the ability of the material to exchange its electrons upon charge/discharge with external circuit with kinetics independent of temperature is desired. The standard parameter for evaluating kinetics independent of temperature is the charge transfer resistance (R_{CT}) that translates the effective ability of a material to exchange its electrons with an external circuit and thus directly drives the power performances of the system.

R_{CT} values usually increase considerably when the temperature decreases, thereby decreasing power performances by slowing the electron exchange kinetics between the material and the external circuit. So far, no technical answer has been developed for battery makers with materials that have equivalent improved electron exchange kinetics at room and at low temperatures.

There is a need for a LiMPO₄ material with improved electron exchange kinetics at low temperature. The embodiments of the invention described overcome the current phosphate based materials limitations by providing a material with R_{CT} values independent from temperature. In addition these R_{CT} values are low, thus making the products usable in real application systems.

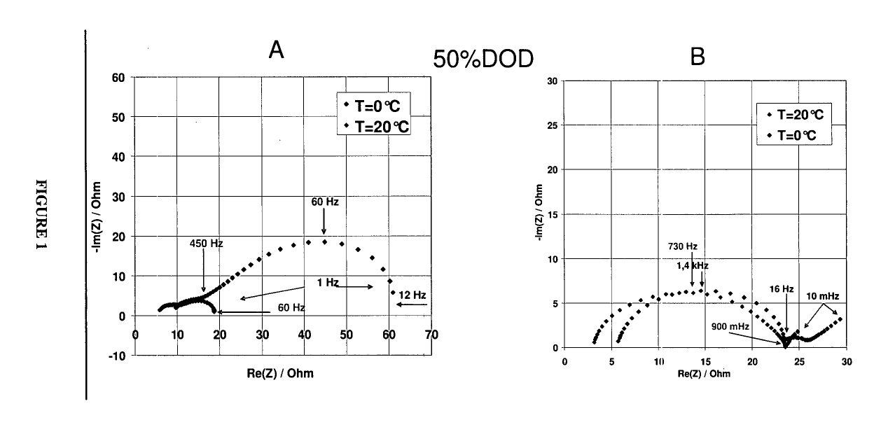

FIG. 1 shows a graph of Impedance spectroscopy plot ImZ=f (ReZ) of the LiMPO₄ material represented by the embodiments and state of the art material at 50% DOD, RT and 0° C.

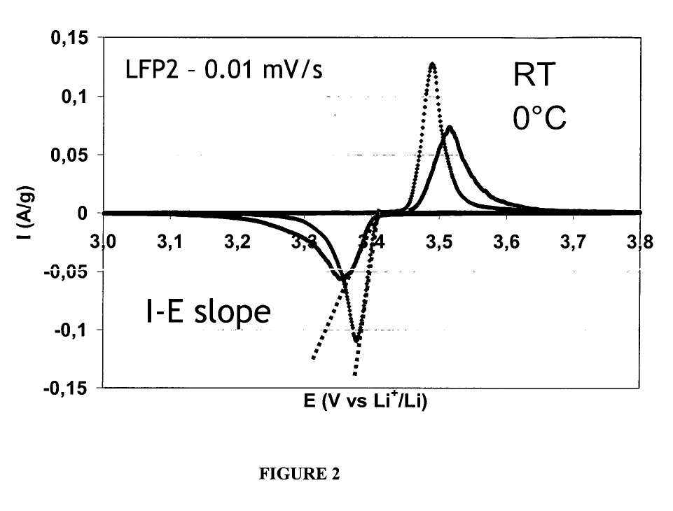

FIG. 2: Cyclic voltammetry measurement I=f(E) of the state of the art material (counter example) at RT and 0° C.

The embodiments of the invention cover LiMPO₄ materials having temperature independent R_{CT} values. These R_{CT} values are in a range which makes the use of the product in a battery feasible. The battery may be operated at wide variety of different temperatures. Performance should be steady or achieve an acceptable threshold of performance, e.g. reversible capacity, charge transfer resistance, at temperatures of above 50° C., above 40° C., above 30° C., room temperature, 20° C., 10° C., 4° C., 0° C., below 0° C., below −10° C., below −20° C., below −30° C., and below −40° C. As such, batteries are expected to perform at ranges from about −40° C. to about 50° C., or −30° C. to about 40° C., or about −20° C. to about 10° C., or about −10° C. to about 5° C., or from about −5° C. to 5° C.

Several advantages have been identified in the embodiments of the invention. For example, by utilizing the embodiments one may achieve constant improved electron exchange kinetics independent from temperature variations of the system via a temperature independent R_{CT} constant. Furthermore, one may achieve improved electron exchange kinetics when used at low temperature with low R_{CT} constant at 0° C. It has been surprisingly found that the LiMPO₄ compounds of the embodiments have improved electron exchange kinetics which are independent of temperature variations. This allows for use of the battery in a number of different climates, during different and extreme weather conditions, and in general under a variety of temperatures, including applications in space.

In some embodiments, the use of a LiMPO₄ material with temperature independent R_{CT} values for the manufacture of a lithium insertion-type electrode, by mixing said powder with a conductive carbon-bearing additive, is described. Other embodiments include the corresponding electrode mixture.

In another embodiment, the use of such electrode material in batteries is described. The batteries include, but are not limited to Li batteries. The electrode material may also be used in complex or mixed battery systems, where different types of batteries are utilized. As an example only, batteries may include other alkali metals. According to some embodiments, batteries may include Li, Na, K, Rb, Cs, and Fr in the electrode material.

In one embodiment, the electrode material comprises a material with the formula LiₓMPO₄, wherein M comprises at least one metal, wherein 0≦x≦1, and wherein the LiₓMPO₄ comprises a temperature independent charge transfer resistance. While M comprises at least one metal, this is understood to mean that M may comprise two, three or multiple metals.

In another embodiment the at least one metal may be, for example, a transition metal or a divalent, or trivalent cation. As example only, the following elements may make up the at least one metal: Ti, V, Cr, Mn, Fe, Co, Ni, Cu, Mg, Al, Zr, Nb. Na, or Zn.

In certain embodiments, the at least one metal may be comprised of two metals. Each metal may, as an example only, be chosen from Ti, V, Cr, Mn, Fe, Co, Ni, Cu, Mg, Al, Zr, Nb. Na, or Zn. For compounds with more than one metal, M may be represented by M_{1-y}M_{y}, where the sum of the fractions of the multiple metals adds up to 1. As such, one metal may be represented as 1-y and the other metal may be represented as y, wherein 0<y<1.

For example, possible combinations include, but are not limited to M_{0.5}M_{0.5}, M_{0.6}M_{0.4}, M_{0.7}M_{0.3}, M_{0.8}M_{0.2}, M_{0.9}M_{0.1}, or M_{0.92}M_{0.08}, or M0.₉₅M_{0.05}. M may be represented by a range, for example, about 0.1 to about 0.99, about 0.2 to about 0.99, about 0.3 to about 0.99, about 0.4 to about 0.99, about 0.5 to about 0.99, about 0.6 to about 0.99, about 0.7 to about 0.99, about 0.8 to about 0.99, about 0.9 to about 0.99, about 0.2 to about 0.8, about 0.3 to about 0.7, or about 0.4 to about 0.6.

According to certain embodiments, any combinations of transition metals or divalent, trivalent cations may be suitable. Provided is, as an example only, the following list of combinations represented by the embodiments: Fe/Mn, Fe/Co, Fe/Ni, Fe/Cu, Fe/Mg, Fe/Al, Fe/Zn, Fe/Cr, Fe/V, Fe/Ti, Cr/Mn, Cr/Co, Cr/Ni, Cr/Cu, Mn/Co, Mn/Ni, Mn/Cu, Mn/Mg, Mn/A1, Mn/Zn, Co/Ni, Co/Cu, Ni/Cu, Ni/Mg, Ni/Al, Ni/Zn, or Fe/V.

According to certain aspects, the electrode material comprises an R_{CT} constant of less than about 100 Ohm at about 0° C. as measured by cyclic voltammetry. However, the R_{CT} constant may be measured by any known method and is not limited to cyclic voltammetry, which is only described as an example of one way to measure the R_{CT} constant. Alternatively, the R_{CT} may be measured via impedance spectroscopy. However, if measured by impedance spectroscopy, different values are expected as shown in Tables 1 and 2.

In certain embodiments the R_{CT} constant may be less than about 80 Ohm, less than about 60 Ohm, or less than about 40 Ohm at 0 C. Alternatively, R_{CT} values may also be less than about 80 Ohm, less than about 60 Ohm, or less than about 40 Ohm at other temperatures such as, for example, above about 50° C., at about 40° C., at about 30° C., at about room temperature, at about 20° C., at about 10° C., at about 4° C., at about 0° C., below about 0° C., below about −10° C., below about −20° C., below about −30° C., and below about −40° C. As such, the R_{CT} constant may be measured within ranges from about −40° C. to about 50° C., or −30° C. to about 40° C., or about −20° C. to about 10° C., or about −10° C. to about 5° C., or from about −5° C. to 5° C. As such, the R_{CT} constant is temperature independent of temperature and one may obtain less than about 100 Ohm, less than about 80 Ohm, less than about 60 Ohm, or less than about 40 at any temperature range.

According to certain embodiments, the R_{CT} constant is independent over a temperature range from about 25 C to about 0 C. In another embodiment, the R_{CT} constant is independent over a temperature range from about 25 C to about −10 C, or the R_{CT} constant is independent over a temperature range from about 4° C. to about −10 C, or the R_{CT} constant is independent over a temperature range from about 4° C. to about −20 C.

In certain embodiments the electrode material also has a carbon coating as seen in WO2004/001881, which is hereby incorporated by reference in its entirety. The combination of the carbon coating and the temperature independent R_{CT} constants may further ensure that batteries with an electrode material according to the embodiments may be used in real life applications.

Certain embodiments include a positive electrode material comprising a material with the formula LiₓM_{1-y}M_{y}PO4, a carbon coating, wherein the LiₓM_{1-y}M_{y}PO4 material contains about less than 3% carbon, wherein M_{1-y} comprises Fe and M_{y} comprises Mn, wherein 0≦x≦1, wherein 0≦y≦1, and wherein the LiₓMPO₄ comprises a R_{CT} constant of less than about 60 Ohm at about 0 C, and wherein the charge transfer resistance is independent of temperature.

Some embodiments include a positive electrode material comprising a material with the formula LiₓM_{1-y}M_{y}PO4, a carbon coating, wherein M_{1-y} comprises Fe and M_{y} comprises Mn, wherein 0≦x≦1, wherein 0≦y≦1, and wherein the LiₓMPO₄ comprises a R_{CT} constant of less than about 60 Ohm at about 0 C, and wherein the charge transfer resistance is independent of temperature.

Without wishing to be bound by any particular theory, it is believed that the direct precipitation of crystalline LFMP at low temperature prevents any grain growth linked to sintering processes. Nanometric particle sizes are obtained. This may reduce kinetic limitations due to Li ions transport within the particle, thereby enhancing the fast charge/discharge behaviour of the batteries.

Without wishing to be bound by any particular theory, it is believed that the narrow particle size distribution ensures a homogeneous current distribution within the battery. This is especially important at high charge/discharge rates, where finer particles would get more depleted than coarser ones, a phenomenon leading to the eventual deterioration of the particles and to the fading of the battery capacity upon use. Furthermore, it facilitates manufacturing of the electrode.

In addition to using compounds with low R_{CT} constant, one may also reduce particle size to achieve satisfactory performance. Furthermore, one may narrow the particle size distribution in order to ensure a homogeneous current distribution in the electrode and thus achieve better battery performances, in particular high power efficiency and long cycle life. Certain embodiments aim at providing a crystalline LMPO₄ powder with, low R_{CT}, temperature independent R_{CT}, small particle size, and narrow particle size distribution.

Some embodiments represent the synthesis of crystalline LiFe_{1-y}M_{y}PO₄ powder where M is one or both of Co and Mn, and 0<x<1, preferably 0.4<x<0.95, comprises the steps of:

providing a water-based mixture having a pH between 6 and 10, containing a dipolar aprotic additive, and Li(I), Fe(II), P(V), and one or both of Co(II) and Mn(II) as precursor components; heating said water-based mixture to a temperature less than or equal to its boiling point at atmospheric pressure, thereby precipitating crystalline LiFe_{1-y}MₓPO₄ powder. The obtained powder can be subjected to a post-treatment by heating it in non-oxidising conditions.

A pH of between 6 and 8 avoids any precipitation of Li₃PO₄. The additive may be a dipolar aprotic compound without chelating or complexation propensity. The heating temperature of the water-based mixture may be at least 60° C.

The production of the crystalline LiFe_{1-y}M_{y}PO₄ powder or the thermal post-treatment may be performed in the presence of at least one further component, in particular a carbon containing or electron conducting substance, or the precursor of an electron conducting substance.

It is useful to introduce at least part of the Li(I) is as LiOH. Similarly, at least part of the P(V) may be introduced as H₃PO₄. The pH of the water based mixture may be obtained by adjusting the ratio of LiOH to H₃PO₄.

A water-based mixture with an atmospheric boiling point of between 100 and 150° C., or between 100 and 120° C., may be used. Dimethylsulfoxide (DMSO) may be used as the dipolar aprotic additive. The water-based mixture may contain between 5 and 50% mol, and or between 10 and 30% mol, of DMSO. A lower DMSO concentrations may result in a coarser particle size distribution; higher concentrations limit the availability of water, forcing to increase the volume of the apparatus.

The step of post treatment of the LiFe_{1-y}M_{y}PO₄ may be performed at a temperature of up to 675° C., or of at least 300° C. The lower limit is chosen in order to enhance the crystallinity or crystalline nature of the precipitated LiFe_{1-y}M_{y}PO₄; the upper limit may be chosen so as to avoid the decomposition of the LiFe_{1-y}M_{y}PO₄ into manganese phosphides.

The electron conducting substance may be carbon, for example conductive carbon or carbon fibers. Alternatively, a precursor of an electron conducting substance may be used, for example a polymer or sugar-type macromolecule.

The invention also pertains to a crystalline LiFe_{1-y}M_{y}PO₄ powder with 0<x<1, or 0.4<x<0.95, for use as electrode material in a battery, having a particle size distribution with an average particle size d50 of less than 100 nm, or of more than 30 nm. The maximum particle size may be less than or equal to 500 nm. The particle size distribution may be mono-modal and the ratio (d90−d10)/d50 may be less than 1.5, preferably less than 1.3.

Another embodiment concerns a composite powder containing a crystalline LiMnPO₄ powder, and up to 10% wt of conductive additive.

A further embodiment concerns the electrode mix that can be prepared using this composite powder. Conductive carbons, carbon fibers, amorphous carbons resulting from decomposition of organic carbon containing substances, electron conducting polymers, metallic powders, and metallic fibers may be used as conductive additives.

Another embodiment concerns the use of the composite powder for the manufacture of a lithium insertion-type electrode, by mixing said powder with a conductive carbon-bearing additive.

The embodiments also pertains to a crystalline LiFe_{1-y}Co_{y}PO₄ powder with 0<x<1, or 0.4<x<0.95, for use as electrode material in a battery, having a particle size distribution with an average particle size d50 of less than 300 nm, or of more than 30 nm. The maximum particle size may be less than or equal to 900 nm. The particle size distribution may be mono-modal and the ratio (d90−d10)/d50 may be less than 1.5, preferably less than 1.1.

Another embodiment concerns a composite powder containing the above-defined crystalline LiFe_{1-y}Co_{y}PO₄ powder, and up to 10% wt of conductive additive. A further embodiment concerns the electrode mix that can be prepared using this composite powder. Conductive carbons, carbon fibers, amorphous carbons resulting from decomposition of organic carbon containing substances, electron conducting polymers, metallic powders, and metallic fibers may be used as conductive additives.

Another embodiment concerns the use of the composite powder for the manufacture of a lithium insertion-type electrode, by mixing said powder with a conductive carbon-bearing additive.

The atmospheric boiling point of the water-based mixture may be between 100 and 150° C., or between 100 and 120° C. Use may be made of a water-miscible additive as a co-solvent that may increase the precipitate nucleation kinetics thus reducing the size of LiFe_{1-y}Mn_{y}PO₄ nanometric particles. In addition to be miscible with water, useful co-solvents may be aprotic, i.e. show only a minor or complete absence of dissociation accompanied by release of hydrogen ions. Co-solvents showing complexation or chelating properties such as ethylene glycol do not appear suitable as they will reduce the kinetics of precipitation of LiFe_{1-y}Mn_{y}PO₄ and thus lead to larger particle sizes. Suitable dipolar aprotic solvents are dioxane, tetrahydrofuran, N—(C₁-C₁₈-alkyl)pyrrolidone, ethylene glycol dimethyl ether, C₁-C₄-allylesters of aliphatic C₁-C₆-carboxylic acids, C₁-C₆-diallyl ethers, N,N-di-(C₁-C₄-alkyl)amides of aliphatic C₁-C₄-carboxylic acids, sulfolane, 1,3-di-(C₁-C₈-alkyl)-2-imidazolidinone, N—(C₁-C₈-alkyl)caprolactam, N,N,N′,N′-tetra-(C₁-C₈-allypurea, 1,3-di-(C₁-C₈-alkyl)-3,4,5,6-tetrahydro-2(1H)-pyrimidone, N,N,N′,N′-tetra-(C₁-C₈-alkyl)sulfamide, 4-formylmorpholine, 1-formylpiperidine or 1-formylpyrrolidine, N—(C₁-C₁₈-alkyl)pyrrolidone, N-methylpyrrolidone (NMP), N-octylpyrrolidone, N-dodecylpyrrolidone, N,N-dimethylformamide, N,N-dimethylacetamide or hexamethylphosphoramide. Other alternatives such as tetraalkyl ureas are also possible. Mixtures of the abovementioned dipolar aprotic solvents may also be used. In a preferred embodiment, dimethylsulfoxide (DMSO) is used as solvent.

### EXAMPLES

The invention is further illustrated in the following examples:

### Example 1

In a first step, DMSO was added to an equimolar solution of 0.1M Fe^{(II)} in FeSO₄.7H₂0 and 0.1M P^{(V)} in H₃PO₄, dissolved in H₂O under stirring. The amount of DMSO was adjusted in order to reach a global composition of 50% vol water and 50% vol DMSO.

In a second step, an aqueous solution of 0.3 M LiOH.H₂O was added to the solution at 25° C.; in order to increase the pH up to a value between 6.5 and 7.5. Hence, the final Li:Fe:P ratio is close to 3:1:1.

In a third step, the temperature of the solution was increased up to the solvent boiling point, which is 108 to 110° C. After 6 h, the obtained precipitate is filtered and washed thoroughly with water. The pure crystalline LiFePO₄ was poured into a 10% wt aqueous solution of sucrose (100 g LiFePO₄ for 45 g sucrose solution) and stirred for 2 h. The mixture was dried at 150° C. under air during 12 h and, after careful deagglomeration, heat treated at 600° C. for 5 h under a slightly reducing N₂/H₂ 90/10 flow.

A well crystallized LiFePO₄ powder containing 2.6% wt carbon coating was produced this way.

A slurry was prepared by mixing the LiFePO₄ powder obtained according to the invention described above with 5% wt carbon black and 5% PVDF into N-Methyl Pyrrolidone (NMP) and deposited on an Al foil as current collector. LM2425-type coin cells with Li metal as negative electrode material assembled in an Ar-filled glovebox.

Electrochemical impedance spectroscopy measurements were performed on electrodes containing material from Example A charged at 50% of their total capacity, between 65 kHz and 10 mHz, using an Autolab PGStat30 in a galvanostatic mode. The electrochemical response is shown in FIG. 1. R_{IS}, related to charge transfer resistance of the electrodes when an AC current is applied could be calculated from the fitting of the 2^{nd} arc circle and are summarized in Table 1.

Cyclic voltammetry tests for material from Example A were performed on a Multipotentiostat VMP cycler (BioLogic), using. Different temperatures were evaluated at a scanning rate of 0.01 mV/s, between 2.5 and 4.5V vs. Li. As shown in FIG. 2, 1/Slope of I=f(E) gives R_{CV} related to charge-transfer mechanisms in the electrode when a DC current is applied. The R_{CV} values for Example A are summarized in Table 1.

The results compiled in Table 1 clearly show that whatever the type of electrical stimulus to the system (DC or AC), the charge transfer resistance is significantly increased (×3 to ×4) when decreasing temperature from RT (25° C.) to 0° C. This is a normally observed behaviour for polyanionic type materials.

### Example 2

In a first step, DMSO was added to an equimolar solution of 0.008 M Mn^{(II)} in MnSO₄.H₂O, 0.092 M Fe^{(II)} in FeSO₄.7H₂0 and 0.1M P^{(V)} in H₃PO₄, dissolved in H₂O under stirring. The amount of DMSO was adjusted in order to reach a global composition of 50% vol water and 50% vol DMSO.

In a second step, an aqueous solution of 0.3 M LiOH.H₂O was added to the solution at 25° C.; in order to increase the pH up to a value between 6.5 and 7.5. Hence, the final Li:Fe:Mn:P ratio is close to 3:0.92:0.08:1.

In a third step, the temperature of the solution was increased up to the solvent boiling point, which is 108 to 110° C. After 6 h, the obtained precipitate was filtered and washed thoroughly with water. The pure crystalline LiFe_{0.92}Mn_{0.08}PO₄ was poured into a 10% wt aqueous solution of sucrose (100 g LiFe_{0.92}Mn_{0.08}PO₄ for 45 g sucrose solution) and stirred for 2 h. The mixture was dried at 150° C. under air during 12 h and, after careful deagglomeration, heat treated at 600° C. for 5 h under a slightly reducing N₂/H₂ 90/10 flow.

A well crystallized LiFe_{0.92}Mn_{0.08}PO₄ powder containing 2.3% wt carbon coating was produced this way.

A slurry was prepared by mixing the LiFe_{0.92}Mn_{0.08}PO₄ powder obtained according to the invention described above with 5% wt carbon black and 5% PVDF into N-Methyl Pyrrolidone (NMP) and deposited on an Al foil as current collector.

LM2425-type coin cells with Li metal as negative electrode material assembled in an Ar-filled glovebox.

Electrochemical impedance spectroscopy measurements were performed on electrodes containing material from Example B charged at 50% of their total capacity, between 65 kHz and 10 mHz, using an Autolab PGStat30 in a galvanostatic mode. The electrochemical response is shown in FIG. 1. R_{IS}, related to charge transfer resistance of the electrodes when an AC current is applied could be calculated from the fitting of the 2^{nd} arc circle and are summarized in Table 1.

Cyclic voltammetry tests for material from Example B were performed on a Multipotentiostat VMP cycler (BioLogic). Different temperatures were evaluated at a scanning rate of 0.01 mV/s, between 2.5 and 4.5V vs. Li. The R_{CV} values for Example B are summarized in Table 1.

TABLE 1

| Material | Temp. | R_{CV} (Ω) | R_{IS} (Ω) |
|---|---|---|---|
| LFP | RT | 37/38 | 8 |
| | 0° C. | 108/108 | 39 |
| LM_{1-y}M_{y}PO₄ | RT | 44/48 | 21 |
| | 0° C. | 42/55 | 19 |

Surprisingly, the results compiled in Table 1 for Example 2B show that whatever the type of electrical stimulus to the system (DC or AC) is, the charge transfer resistance is constant when decreasing temperature from RT (25° C.) to 0° C. Another important feature is that, in addition to be independent from T, the charge transfer resistance is low and in the usable range for this material to be applied in real battery systems.

### Example 3

Cyclic voltammetry tests for material from Example B are performed on a Multipotentiostat VMP cycler (BioLogic). Different temperatures are evaluated at a scanning rate of 0.01 mV/s, between 2.5 and 4.5V vs. Li. The R_{CV} values may be less than 80 Ohm or less than 60 Ohm or less than 40 Ohm at temperatures of 50° C., 40° C., 30° C., −5° C., −10° C., −°20 C. It is expected that the R_{CT} values remain constant and do not vary significantly with temperature.

TABLE 2

| Material | Temp. | R_{CV} (Ω) | R_{IS} (Ω) |
|---|---|---|---|
| LM_{1-y}M_{y}PO₄ | 50° C. | 46/46 | 22 |
| | 40° C. | 45/44 | 21 |
| LM_{1-y}M_{y}PO₄ | −10° C. | 40/57 | 19 |
| | −20° C. | 38/59 | 18 |

### Example 4

### Synthesis of LiFe_{0.5}Mn_{0.5}PO₄

In a first step, DMSO is added to an equimolar solution of 0.05 M Mn^{(II)} in MnNO₃.4H₂O, 0.05 M Fe^{(II)} in FeSO₄.7H₂O and 0.1M P^{(V)} in H₃PO₄, dissolved in H₂O while stirring. The amount of DMSO is adjusted in order to reach a global composition of 50% vol water and 50% vol DMSO corresponding to respectively about 80% mol and 20% mol.

In a second step, an aqueous solution of 0.3 M LiOH.H₂O is added to the solution at 25° C.; the pH hereby increases to a value between 6.5 and 7.5. The final Li:Fe:Mn:P ratio is close to 3:0.5:0.5:1.

In a third step, the temperature of the solution is increased up to the solvent boiling point, which is 108 to 110° C. After 18 h, the obtained precipitate is filtered and washed thoroughly with water. The pure crystalline LiFe_{0.5}Mn_{0.5}PO₄ obtained is shown in FIG. 1.

The refined cell parameters are a=10.390 Å, b=6.043 Å; c=4.721 Å, with a cell volume of 296.4 Å³. This is in good agreement with Vegard's law specifying that, in case of solid solution, the cell volume of mixed product should be in-between that of end products (291 Å³ for pure LiFePO₄, 302 Å³ for pure LiMnPO₄).

Monodisperse small crystalline particles in the 50-100 nm range were obtained. The volumetric particle size distribution of the product was measured using image analysis. The d50 values is about 80 nm, while the relative span, defined as (d90−d10)/d50, is about 1.2 (d10=45 nm, d90=145 nm).

### Example 5

### Synthesis of LiFe_{0.5}Co_{0.5}PO₄

In a first step, DMSO is added to an equimolar solution of 0.05 M Mn^{(II)} in MnSO₄.H₂O, 0.05 M Co^{(II)} in CoNO₃.6H₂O and 0.1M P(V) in H₃PO₄, dissolved in H₂O while stirring. The amount of DMSO is adjusted in order to reach a global composition of 50% vol. water and 50% vol. DMSO.

In a second step, an aqueous solution of 0.3 M LiOH.H₂O is added to the solution at 25° C.; the pH hereby increases to a value between 6.5 and 7.5. The, the final Li:Fe:Co:P ratio is close to 3:0.5:0.5:1.

In a third step, the temperature of the solution is increased up to the solvent boiling point, which is 108 to 110° C. After 18 h, the obtained precipitate is filtered and washed thoroughly with water. The pure crystalline LiFe_{0.5}Co_{0.5}PO₄ obtained is shown in FIG. 4.

The refined cell parameters are a=10.292 Å, b=5.947 Å; c=4.712 Å with a cell volume of 288.4 Å³. This is again in good agreement with Vegard's law specifying that, in case of solid solution, the cell volume of mixed product should be in-between that of end products (291 Å³ for pure LiFePO₄, 284 Å³ for pure LiCoPO₄).

Monodisperse small crystalline particles in the 200-300 nm range were obtained. The volumetric particle size distribution of the product was measured by using image analysis. The d50 values is about 275 nm, while the relative span, defined as (d90−d10)/d50, is about 1.0 (d10=170 nm, d90=450 nm).

The invention can alternatively be described by the following clauses:

An electrode material comprising: a material with the formula LiₓMPO₄; wherein M comprises at least one metal, wherein 0≦x≦1, and wherein the LiₓMPO₄ comprises a temperature independent charge transfer resistance transfer.

An electrode material, wherein the at least one metal comprises a transition metal or a divalent/trivalent cation.

An electrode material, wherein the at least one metal is selected from the group consisting of Ti, V, Cr, Mn, Fe, Co, Ni, Cu, Mg, Al, Zr, Nb. Na, or Zn.

An electrode material, wherein the at least one metal comprises at least two metals.

An electrode material, wherein the at least two metals are selected from the group consisting of Ti, V, Cr, Mn, Fe, Co, Ni, Cu, Mg, Al, Zr, Nb. Na, or Zn.

An electrode material, wherein one metal is present in an amount of 1-y and wherein the other metal(s) are present in an amount of y, wherein 0<y<1.

An electrode material, wherein the electrode material comprises a R_{CT} constant of less than about 100 Ohm at about 0° C. as measured by cyclic voltammetry.

An electrode material, wherein the electrode material comprises a R_{CT} constant of less than about 60 Ohm at about 0° C. as measured by cyclic voltammetry.

An electrode material, wherein the temperature independent charge transfer resistance is independent over a temperature range from about 25° C. to about 0° C.

An electrode material, wherein the temperature independent charge transfer resistance is independent over a temperature range from about 25° C. to about −10° C.

An electrode material, wherein the temperature independent charge transfer resistance is independent over a temperature range from about 40° C. to about −10° C.

An electrode material, wherein the temperature independent charge transfer resistance is independent over a temperature range from about 40° C. to about −20° C.

An electrode material of claim 1, wherein the LiₓMPO₄ comprises a carbon coating.

An electrode material, wherein the LiₓMPO₄ comprises less than about 3% carbon.

An electrode material, wherein the average LiₓMPO₄ crystal size is smaller than about 1 micron.

A battery comprising an electrode material comprising: a material with the formula LiₓMPO₄; wherein M comprises at least one metal, wherein 0≦x≦1, and wherein the LiₓMPO₄ comprises a temperature independent charge transfer resistance transfer.

A positive electrode material comprising: a material with the formula LiₓM_{1-y}M_{y}PO4; a carbon coating; wherein the LiₓM_{1-y}M_{y}PO4 material contains about less than 3% carbon; wherein M_{1-y} comprises Fe and M_{y} comprises Mn, wherein 0≦x≦1, wherein 0≦y≦1, wherein the LiₓMPO₄ comprises a R_{CT} constant of less than about 60 Ohm at about 0° C., and wherein the charge transfer resistance is independent of temperature.

An electrode material comprising: a LiₓFe_{y}M_{z}P_{w}O₄ compound for an electrode for a Li rechargeable battery, wherein 0.90<=x<=1.03, 0.85<=y<=1.0, 0.01<=z<=0.15, 0.90<=w<=1.0, 1.9<=x+y+z<=2.1; wherein M comprises at least one element selected from the group consisting of Mn, Co, Mg, Cr, Zn, Al, Ti, Zr, Nb, Na, and Ni; and wherein the compound comprises a charge transfer resistance increase of less than 20% between room temperature and 0° C.

An electrode material, wherein the charge transfer increase is less than about 10%.

An electrode material, wherein the charge transfer increase is about 0%.

1-15. (canceled)

16. An electrode material comprising:
a material with the formula LiₓMPO₄; wherein M comprises at least one metal, wherein 0≦x≦1, and wherein the LiₓMPO₄ material has a temperature independent charge transfer resistance.

17. The electrode material of claim 16, wherein the at least one metal comprises a transition metal or a divalent/trivalent cation.

18. The electrode material of claim 16, wherein the at least one metal is selected from the group consisting of Ti, V, Cr, Mn, Fe, Co, Ni, Cu, Mg, Al, Zr, Nb, Na, and Zn.

19. The electrode material of claim 16, wherein M comprises at least two metals.

20. The electrode material of claim 19, wherein the at least two metals are selected from the group consisting of Ti, V, Cr, Mn, Fe, Co, Ni, Cu, Mg, Al, Zr, Nb, Na, and Zn.

21. The electrode material of claim 19, wherein one metal is present in an amount of 1-y and wherein the other metal(s) are present in an amount of y, wherein 0<y<1.

22. The electrode material of claim 16, wherein the electrode material has an R_{CT} constant of less than about 100 Ohm at about 0° C. as measured by cyclic voltammetry.

23. The electrode material of claim 16, wherein the temperature independent charge transfer resistance is independent over a temperature range from about 40° C. to about −20° C.

24. The electrode material of claim 16, wherein the LiₓMPO₄ material comprises a carbon coating.

25. The electrode material of claim 24, wherein the LiₓMPO₄ material comprises less than about 3% carbon.

26. The electrode material of claim 16, wherein the LiₓMPO₄ material is in crystal form and the average crystal size is smaller than about 1 micron.

27. A battery comprising the electrode material of claim 16.

28. A positive electrode material comprising:
a material with the formula LiₓM_{1-y}M_{y}PO₄;
a carbon coating; wherein the LiₓM_{1-y}M_{y}PO₄ material contains less than about 3% carbon; wherein M_{1-y} comprises Fe and M_{y} comprises Mn,
wherein 0≦x≦1,
wherein 0≦y≦1,
wherein the LiₓM_{(1-y)}M_{y}PO₄ has a R_{CT} constant of less than about 60 Ohm at about 0° C., and wherein the charge transfer resistance is independent of temperature.

29. An electrode material comprising:
a LiₓFe_{y}M_{z}P_{w}O₄ compound for an electrode for a Li rechargeable battery,
wherein 0.90≦x≦1.03, 0.85≦y≦1.0, 0.01≦z≦0.15, 0.90≦w≦1.0, and 1.9≦x+y+z≦2.1; wherein M comprises at least one element selected from the group consisting of Mn, Co, Mg, Cr, Zn, Al, Ti, Zr, Nb, Na, and Ni; and
wherein the compound exhibits a charge transfer resistance increase of less than 20% between room temperature and 0° C.

30. The electrode material of claim 22, wherein the electrode material has an R_{CT} constant of less than about 60 Ohm at about 0° C. as measured by cyclic voltammetry.

31. The electrode material of claim 23, wherein the temperature independent charge transfer resistance is independent over a temperature range from about 40° C. to about −10° C.

32. The electrode material of claim 31, wherein the temperature independent charge transfer resistance is independent over a temperature range from about 25° C. to about −10° C.

33. The electrode material of claim 32, wherein the temperature independent charge transfer resistance is independent over a temperature range from about 25° C. to about 0° C.

34. The electrode material of claim 26, wherein the average crystal size is smaller than about 80 nm.

35. The electrode material of claim 34, wherein the average crystal size is smaller than about 60 nm.
